(19) United States
(12) Patent Application Publication
(10) Pub. No.: US 2006/0123744 A1
(43) Pub. Date: Jun. 15, 2006

(54) Inlet baffle arragement for gas/liquid separation; apparatus; and methods

(75) Inventor: Brian Read, Eagan, MN (US)

Correspondence Address: MERCHANT & GOULD PC, P.O. BOX 2903, MINNEAPOLIS, MN, 55402-0903, US

(73) Assignee: Donaldson Company, Inc., Minneapolis, MN (US)

(21) Appl. No.: 10/537,330

(22) PCT Filed: Dec. 5, 2003
(86) PCT No.: PCT/US03/38822

§ 371 Date: Nov. 4, 2005

Related U.S. Application Data
(60) Provisional application No. 60/431,432, filed on Dec. 6, 2002.

(51) Int. Cl. B01D 50/00

(52) U.S. Cl. 55/337

(57) ABSTRACT

A gas/liquid separator assembly (1) is provided, the assembly (1) generally comprises a vessel (4) with an internally received serviceable separator element (9) arrangement. A unique inlet baffle arrangement (80,82) is provided to facilitate preseparation of liquid from gases, as gases are passed through the assembly (1). The assembly (1) is particularly adapted for use in air/oil separation, for example for compressors. Methods of assembly and use are also described.

This application is being filed as a PCT International Patent Application in the name of Donaldson Company, Inc., a US national corporation and resident, (Applicant for all countries except US) and Brian Read, a US resident and GB citizen (Applicant for US only), on 05 Dec. 2003, designating all countries and claiming priority to U.S. Ser. No. 60/431,432 filed on 06 Dec. 2002.

### FIELD OF THE INVENTION

The present disclosure relates to gas/liquid separations. The disclosure particularly concerns an inlet baffle arrangement for use during a gas/liquid separation. It also concerns an apparatus for gas/liquid separation which utilizes a preferred inlet baffle, and methods of separation. A particular, useful, application is in an air/oil separator for air compressors.

### BACKGROUND

Certain gas/liquid separation assemblies, for example as used with air compressors, include two general components: a vessel with a cover; and, a removable and replaceable (i.e., serviceable) separator element unit, construction or arrangement. In some assemblies a single serviceable separator element is used as the separator element construction; in others, multiple serviceable elements are used. In general, operation involves directing a gas/liquid flow into the vessel. The gas flow is eventually directed through the serviceable separator unit, i.e., through the serviceable separator element or elements. Within the separator unit, liquid coalescing and drainage occurs. As a result, an entrained liquid concentration, within the gas stream, is reduced. Periodically, the serviceable element(s) are removed and replaced.

### SUMMARY

According to the present disclosure a gas/liquid separator assembly is provided. The assembly in general includes a vessel and a preseparation assembly. In use the assembly also includes at least one removable and replaceable; i.e., serviceable, separator element.

In general, the preferred vessel includes an outer wall, typically cylindrical, having gas flow inlet and a lower sump. The inlet is preferably a radial inlet.

The preseparation assembly preferably comprises an inlet baffle arrangement including an axial shroud mounted with an axial extension spaced from the outer wall to define a gas flow annulus. Preferably the axial shroud is a radially continuous, impermeable, structure. The preseparation assembly in general defines a mounting space for at least one removable and replaceable, i.e., serviceable, gas/liquid separator element. The mounting space has an axial dimension, corresponding in general to an axial length of each of the at least one gas/liquid separator elements used with the assembly. Preferably the axial shroud is positioned to extend at least 20% and not more than 60% of the axial length of this mounting space. More preferably the axial shroud is configured to extend at least 35% and not more than 50% of this axial length.

The preseparation assembly; i.e. the inlet baffle arrangement, preferably includes an inlet skirt, which in some embodiments, extends between the axial shroud and the vessel outer wall. A gas flow inlet is preferably positioned to direct inlet gas flow into the gas flow annulus at a location above the inlet skirt. The inlet skirt preferably includes at least one downcomer channel therein, positioned radially spaced from the inlet.

The preferred arrangement includes a radial vane positioned between the downcomer channel and the gas flow inlet at a position to cause gas flow to go through a radial arc or path of at least 70° typically at least 180°, before the gases can pass through the downcomer channel. For certain of particular embodiments depicted, preferably the path is defined to be at least 230°.

A variety of specific preferred configurations and features are described.

The disclosure also provides preferred inlet skirt arrangements, for use in preferred gas/liquid separator assemblies.

The disclosure also relates to methods of assembly and use. In particular a method of assembly would involve positioning a preseparation assembly or inlet baffle arrangement as defined above, inside of a vessel for gas/liquid separator assembly, to define a preferred inlet annulus and other features. A preferred method of use involves directing gas flow having liquid therein, through a preseparation assembly as defined, and then through a serviceable separator element. Such a method would typically include collecting at least a portion of separated liquid in a lower sump within the gas/liquid separator assembly. The method would preferably include directing the gas flow into the preseparation assembly as described.

### BRIEF DESCRIPTION OF THE DRAWINGS

FIG. 1 is a schematic, side, cross-sectional view of a gas/liquid separator assembly according to a first embodiment of the present disclosure.

FIG. 2 is a perspective view of a preseparator component of the arrangement depicted in FIG. 1.

FIG. 3 is a top perspective view of an inlet baffle skirt of the arrangement depicted in FIGS. 1 and 2.

FIG. 4 is a side, cross-sectional view of a gas/liquid separator assembly according to a second embodiment of the present disclosure.

FIG. 5 is a cross-sectional view taken generally along line 5-5, FIG. 4.

FIG. 6 is a side, cross-sectional view of a gas/liquid separator assembly according to a third embodiment of the present disclosure.

FIG. 7 is a perspective view of a preseparator component of the embodiment shown in FIG. 6.

FIG. 8 is a perspective view of an inlet baffle skirt of the arrangement depicted in FIGS. 6 and 7.

FIG. 9 is a schematic, side, cross-sectional view of a gas/liquid separator assembly according to a fourth embodiment of the present disclosure.

FIG. 10 is a fragmentary cross-sectional view, taken at right angles to FIG. 9.

FIG. 11 is a cross-sectional view taken along line 11-11, FIG. 9.

FIG. 12 is a side, cross-sectional view of a component useable in a preseparator portion of the assembly depicted in FIG. 9.

### DETAILED DESCRIPTION

### I. General Background

In general, gas/liquid separator assemblies of the type of concern herein, include three general components: a vessel arrangement; an inlet baffle arrangement; and, an internally received, removable and replaceable, (i.e., serviceable) separator arrangement. The internally received, removable and replaceable, (i.e., serviceable) separator arrangement generally comprises one or more separators (or separator elements) that, in time, are removed and replaced during servicing operations; hence the term “serviceable.” Each serviceable separator element includes a media pack, through which the gases are passed. Each media pack typically includes layers of media for coalescing and drain steps.

Herein, gas/liquid separator assemblies or separator-elements will be classified as either “in-to-out flow” or “out-to-in flow,” depending on whether, in use, during gas flow through the media pack of each separator element, gas flow is directed from an outside of the serviceable separator element(s) to an interior; or, from an interior of the serviceable separator element(s), to an exterior. The techniques described herein can be applied to either or both. Examples of both types of arrangements are provided.

A typical application for the techniques described herein, is as a gas/oil (specifically air/oil) separator for a compressor arrangement. Such an apparatus is generally adapted for operation with internal pressures on the order of about 60 psi to 200 psi (about 4.2-14.06 kg/sq.cm), for example about 80-120 psi (about 5.6-8.44 kg/sq.cm), typically about 100 psi (about 7 kg/sq.cm). Examples of use would be with compressors of 20 hp to 500 hp (about 14.9-373 Kw).

The through put for an air/oil separator for use with a compressor arrangement, is typically measured in terms of volume of free air (i.e., non-compressed volume) passed through the separator assembly. A typical operating flow would be from on the order of 100 cubic feet per minute (47,000 cu.cm/sec.) up to several thousand cubic feet per minute (about 1 million cu.cm/sec. or more).

Herein, some particular arrangements are described and shown. The dimensions of specific configurations discussed, are for typical example applications. The techniques and principles described herein can be applied in a variety of systems of a variety of sizes, for use with a wide variety of equipment types and sizes (for example a variety of compressors).

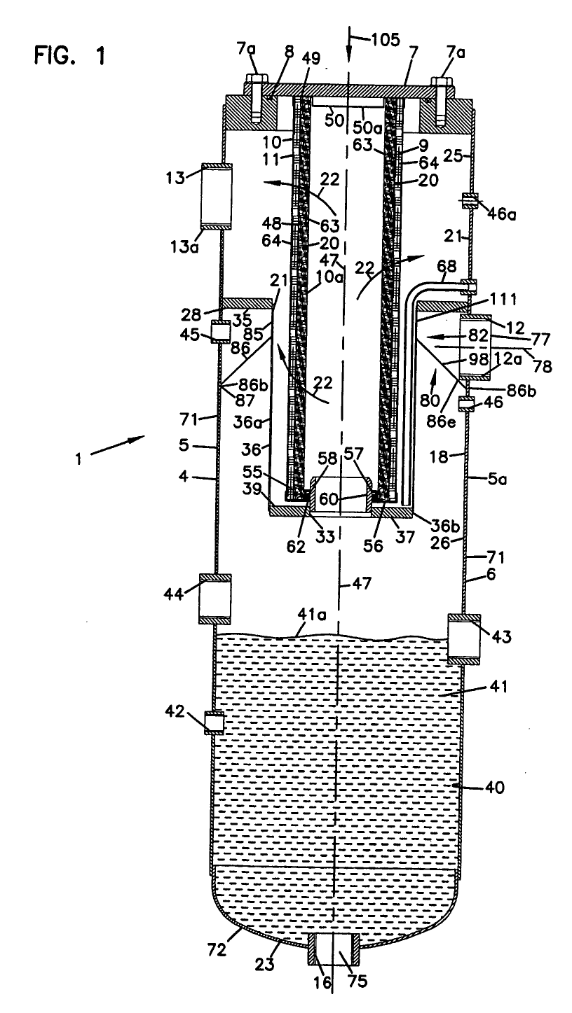

### II. The Embodiment of FIGS. 1-3.

In FIGS. 1-3, a gas/liquid separator usable as an air/oil separator that includes a preferred assembly according to the present disclosure is depicted. The particular assembly depicted in FIG. 1 is configured for use with an internal pressure of about 100 psi (7 kg/sq.cm) (for example 60-200 psi) (4.2-14.1 kg/sq.cm), and for use with a compressor having a rating of about 100-150 hp (74.6-112 Kw), for example about 125 hp (93 Kw). The through put for such an arrangement would generally be on the order of about 500 cfm (about 236,000 cu.cm/sec.)

The reference number 1, FIG. 1, generally designates a gas/liquid separator assembly according to a first embodiment of the present disclosure. In general, the assembly 1 comprises: a vessel 4, in this instance a pressure vessel 5, including housing 6 and cover 7; and, an internally received, removable and replaceable or serviceable, separator unit 9, in this instance comprising a single, serviceable, separator element or separator 10. The particular separator 10 depicted is an in-to-out flow separator 11, as will become apparent. An o-ring seal between the cover 7 and housing 6 is shown at 8. The cover 7 is secured in place by bolts 7a.

In general, the pressure vessel 5 includes a gas flow inlet 12, a gas flow outlet 13 and a liquid drain outlet 16. In operation, a gas stream having liquid therein, is directed into an interior 18 of the assembly 1, through inlet 12. Within the assembly 1, the gas stream is eventually directed into an interior region 10a of the separator 10. Eventually the gases pass from interior 10a through media pack 20, of the separator 10, and then pass outwardly from the pressure vessel 5, in this instance through gas flow outlet 13.

The particular arrangement shown in FIG. 1 uses an in-to-out flow separator unit 11. By this, it is meant that when the gases pass through the media pack 20 of the separator unit 11, they pass from interior 10a of separator 10 (defined and surrounded by media pack 20) to an exterior region 21, as indicated by arrows 22.

Still referring to FIG. 1, for the particular assembly 1 depicted: the inlet 12 is a sidewall inlet 12a, meaning it extends through sidewall 5a; outlet 13 is also a sidewall outlet 13a, meaning it extends through sidewall 5a; and, drain 16 is a bottom drain. By “bottom” in this context, reference is meant to a lower portion 23 of assembly 1 when oriented for typical use, as shown in FIG. 1. The term “sidewall” is meant to refer to the housing wall portion Sa which extends between the cover 7 and the bottom 23.

To facilitate operation, the assembly 1 generally defines an enclosed upper region 25 and an enclosed lower region 26, in this instance separated by tube sheet structure 28. The tube sheet structure 28 is generally solid and non-porous to gas flow there through, except in specific regions as defined. In this instance, the tube sheet structure 28 defines one central aperture 33 therein. But for aperture 33, the tube sheet structure 28 is generally solid and preferably includes: an annular mounting ring 35; a depending central wall 36, in this instance a cylindrical wall 36a; and, a base 37, with central aperture 33 therein. The base 37 is attached at lower edge 36b of wall 36. The wall 36 and base 37 generally define an upper sump 39, discussed below. As will be understood from detailed description below, aperture 33 provides a flow channel for gas flow from lower region 26 into upper region 25, specifically directed into the separator unit 9.

The central wall 36 is preferably a radially continuous wall. By the term “radially continuous” in this context, it is meant that it extends continuously around a central axis 47. There is not specific requirement that the wall 36 be a cylindrical wall 36a. Such a configuration, however, will be convenient when the assembly 1 includes a single, separator element for separator 10.

Lower region 26 includes lower sump region 40, in this instance depicted with liquid (oil) 41 therein. Much of the liquid initially included with the gas flow inlet 12 drains to lower sump region 40, before the gases even pass through aperture 33 into upper region 25.

Still referring to FIG. 1, assembly 1 includes, in region 26, temperature probe port 42, liquid level gauge tap 43, lower sump filler pipe 44, relief value aperture 45 and pressure tap 46. The filler pipe 44 provides for an optional entry of liquid into lower sump 40 to facilitate operation, if desired, for example when the assembly 1 is first put on line. The relief valve aperture 45 allows for pressure relief controlled by a relief valve, not shown. The temperature probe tap 42, level gauge tap 43 and pressure tap 46 are for monitoring equipment. The particular size, number and location of taps and apertures 42, 43, 44, 45 and 46 is a matter of choice, for the particular operation intended. Typically, the liquid fill port 44 will be positioned higher than the level gauge tap 43. Typically the relief port 45 will be positioned in an upper portion of the lower region 26, preferably in a fluid flow communication with an inlet flow annulus as characterized herein below. The radial location (around central axis 47) of relief port 45 relative to inlet 12 is shown in FIG. 1 at about 180°. A more preferred radial location is discussed below.

Referring to FIG. 1, in sump 40, an operating liquid (oil) level 41a is shown. In typical use, the amount of oil contained within sump 40 is a matter of choosing an appropriate oil volume that will lead to a desired average temperature or cooled temperature, appropriate for directing oil from drain 16 back to the mechanical system for the compressor of concern. The temperature probe provided through port 42, can be used to monitor this.

A tap 46a is also positioned through sidewall 5a in region 25, for evaluating pressure in this region.

As indicated, separator 10 is a removable and replaceable, i.e., serviceable, component. The separator 10 in comprises media pack 20 (in this instance a cylindrical media pack 48) secured at one end 49 to an end cap 50. For the particular assembly shown in FIG. 1, the end cap 50 is a closed end cap 50a, meaning that it has no aperture there through which communicates with interior 10aof separator 10.

At an end 55 opposite the end cap 50, the separator 10 includes an end cap 56, with central aperture 57 therein. The central aperture 57 is a gas flow aperture, for passage of gases into interior 10a, during use. In general, aperture 57 is aligned with aperture 33, such that gas flow passing through aperture 33 from region 26 into region 25, is directed into interior 1 Oa of separator 10.

A variety of seal arrangements could be used at the juncture between separator 10 and tube sheet construction 28. For example either radial seals or axial seals or both can be used. In the example shown in FIG. 1, a radial seal structure is used.

More specifically, inside central aperture 57, sealing ring 58 is provided, to cause a radial seal with cylindrical projection 60 on base 37. The projection 60 defines central aperture 33 along with base 37. The sealing ring 58 may comprise, for example, an o-ring 62. The sealing ring 58 generally prevents gases from escaping interior 10a, into region 21, without passage through the media pack 20.

An alternative radial seal would be to include a cylindrical projection (in place of projection 60) as an integral part of end cap 55, with the radial seal being formed around the outside of the projection against the remainder of base 37.

Referring to FIG. 1, it is noted that the axial length of separator 10, is slightly shorter than the distance between cover 7 and base 37. In use, the separator 10 would be installed over tube or projection 60, by hand, through an opening with cover 7 removed. Cover 7 would then be installed in place. Under operating pressures, the separator 10 would typically be biased until it bumps against cover 7. The radial seal arrangement would be configured to allow for this movement, without loss of seal. Construction in this manner facilitates manufacture of the separators 10, since tight manufacturing tolerances for length would not be critical.

The term “radial” when used herein reference to a seal, is meant to refer to a seal positioned for sealing pressure directed radially toward or away from central axis 47. The term “axial” when used in connection with a seal, is meant to refer to a seal with a sealing force directed in the general direction of the longitudinal extension of axis 47. For example the o-ring 8 provides for an axial seal.

In general, if the separator 10 was provided with an axial seal, in general a seal ring would be provided projecting axially outwardly from end cap 56. This seal would be positioned to engage a portion of base 37, during sealing. An arrangement to provide pressure would be needed, to ensure the seal. This pressure could be provided by the cover 7, or by alternate constructions.

The specific construction of the media pack 20 is not critical to the general principles of inlet baffles described herein, and is a matter of choice. In general, the size and construction of the media pack 20 will be selected based upon such issues as the air flow, the level of efficiency desired, the amount of restriction acceptable, the lifetime of use preferred and the size of space available.

Media packs for air/oil separators are described, for example in the U.S. Pat. Nos. 6,093,231; 6,136 016; WO 99/47211; WO 99/43412; U.K. 1,603,519; U.S. Pat. Nos. 6,419,721; and 4,836,931, the complete disclosures of which are incorporated herein by reference. The principles of these types of arrangements, can, for example, be applied for separator units herein.

Media packs for separators 10 will typically include an upstream coalescing stage 63, and downstream drain stage 64. Since the separator 10 is “in-to-out,” the coalescing stage 63 is surrounded by the drain stage 64. Various liner structures or scrim structures to facilitate assembly or operation can be used. In general, in the coalescing stage 63, fine liquid particles carried in the gas stream coalesce. The coalesced liquid particles generally are driven into the drain stage 64, and then drain from the drain stage 64, into upper sump region 39. A scavenge tube or tube arrangement 68 is shown projecting into upper sump 39, for drainage of collected liquid from region 39.

Still referring to FIG. 1, pressure vessel 5 has a cylindrical outer wall 71 and a rounded bottom 72. The cylindrical outer wall 71 defines the central axis 47 which generally passes through a center 75 of the rounded bottom 72.

In general, gas/liquid separators of the type of concern here are provided with one of two types of gas inlet arrangements. A first, generally referred to herein as a tangential gas inlet, is a gas inlet which has a center line directed generally tangentially with respect to the rounded or cylindrical outer wall. The drawings of this disclosure do not show a tangential inlet, but a conventional one could be used with many of the disclosed principles. In general, housings having tangential inlets are relatively expensive to manufacture, by comparison to the second type of gas inlet discussed below. Thus, it may be preferred to avoid tangential outlets, for cost reasons.

The second type of gas inlet, shown in FIG. 1, is generally referred to herein as a “radial” or “radially directed” inlet. The particular inlet 12 depicted in FIG. 1 is a radially directed inlet 77. In general, a radially directed inlet 77 is an inlet directed with a gas flow generally toward the central longitudinal axis 47 of the pressure vessel 5. For the particular example shown, center line 78 of gas inlet 77 is directed to intersect axis 47, although this is not specifically required.

It should be apparent why radial inlets are less expensive than tangential inlets. In particular, a radial inlet is typically merely an aperture provided in the sidewall 71, with a feed tube or similar structure secured thereto.

Still referring to FIG. 1, the assembly 1 includes a preseparation arrangement 80. In general, the preseparation arrangement 80 provides for some initial separation of gas and liquid, upon gas/liquid flow entering interior 18, through entrance or inlet 12. For the particular arrangement depicted, the preseparation arrangement 80 includes an inlet baffle arrangement 82.

In general terms, the inlet baffle arrangement 82 of the preseparation arrangement 80 is configured and positioned so that when liquid and gases enter inlet 12, they are moved through an arcuate path which: tends to drive a portion of the liquid into baffle or wall structure, for collection and drainage out of the gas flow; and, which directs the gases (gas/liquid mixture) into a preferred flow path, to facilitate separation. In general, an object is to obtain substantial gas/liquid separation, before the gases are passed into the serviceable separator unit 9, without undesirable levels of restriction.

Many air/oil separators utilized with compressors are used in circumstances in which the inlet flow includes not only oil particles entrained in gases, but also a large amount of bulk liquid oil flow. Such an oil flow into the separator assembly 1, for example, can be on the order of 8 to 100 gallons per minute (about 30-380 liters/minute). Thus, the assembly 1 must be configured to manage a large amount of bulk oil flow, along with the gas flow and gas/liquid separation.

The particular inlet baffle arrangement 82 depicted includes: axial shroud 85; and, inlet skirt 86. The axial shroud 5 preferably comprises an outer surface to wall 36. Thus, preferably the axial shroud 5 is cylindrical, and most preferably is radially continuous.

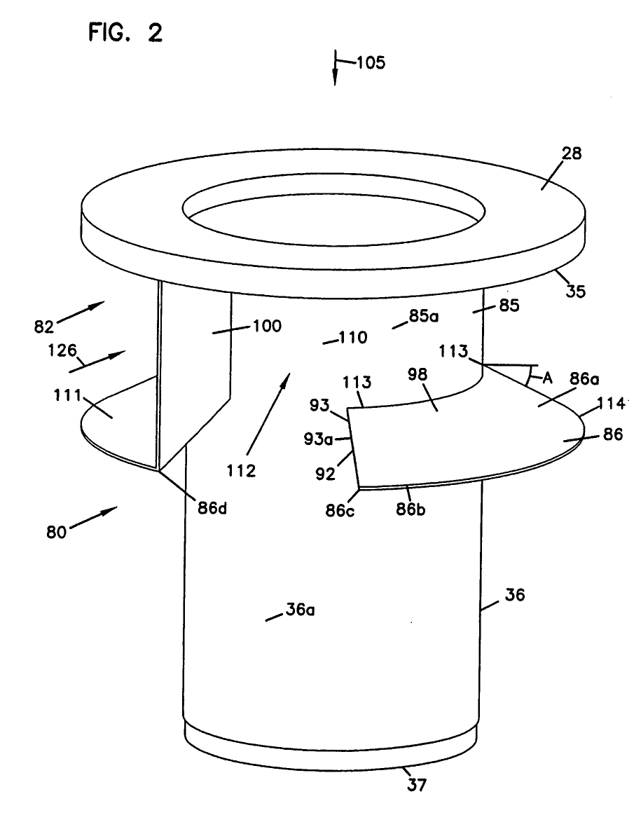

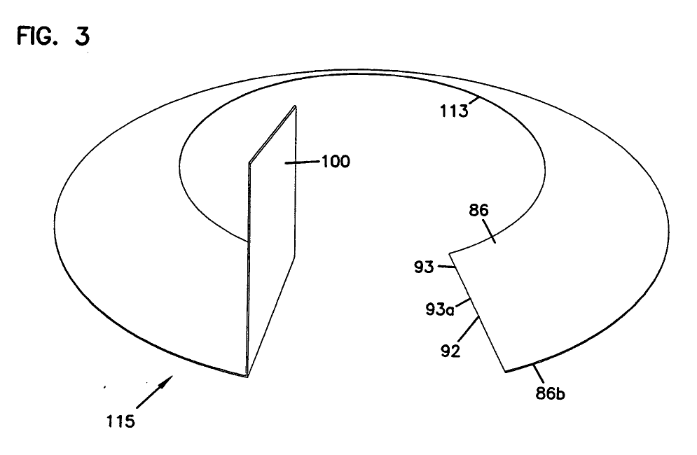

The inlet skirt 86 is generally ring-shaped and extends radially outwardly (relative to axis 47) in extension between the axial shroud 85 and interior surface 87 of housing wall 71. As will be apparent from the following, the particular preferred inlet skirt 86 depicted. FIG. 3, is not radially continuous. The inlet skirt 86 defines a downcomer or channel arrangement 92 (not shown in FIG. 1, see FIG. 2). In this instance the downcomer or channel 92 comprises a portion 93 in inlet skirt 86 opening a space between the axial shroud 85 and sidewall 71. A variety alternative downcomers could be used, the one shown, involving a single space 93, being a convenient example.

In general, in FIG. 2 a portion of the preseparator arrangement 80, which in general comprises the portions attached to and suspended from sidewall 71, are depicted. In FIG. 3, inlet skirt 86 is depicted.

Referring to FIG. 2, preferably inlet skirt 86 includes an upper surface 86a configured as a radial drainage declination surface, to cause drainage of liquid collected thereon, by gravity, toward a radially outer edge 86b of the skirt 86. In this way, liquid collected on surface 86a will tend to drain toward inner surface 87 of wall 71, FIG. 1. This will include the bulk oil flow.

Referring again to FIG. 1, as a gas/liquid combination enters pressure vessel 5 through entrance 12, the initial inlet flow is directed into preseparation arrangement 82. In the preseparation arrangement 82, the gas flow is initially directed toward axial shroud 85 and radial skirt 86. A portion of the liquid contained within the gas stream, will tend to collect on the shroud 85 and radial skirt upper surface 86a. Due to the downward and outer taper or slant (decline) of the skirt 86, in extension from the shroud 85 to wall 87, the collected liquid will tend to flow under gravity, toward the outer wall 87. Eventually, the liquid will drain from region 98 (defined above skirt upper surface 86a) down into lower sump 40, by passage through downcomer or channel 92. In general, bulk liquid flow toward downcomer 92 will be facilitated by the gas flow.

Referring to FIG. 2, in general edge 86c of skirt 86 is positioned at the same axial height as is edge 86d. This will be a particularly convenient construction to manufacture, with techniques as characterized below. If desired, edge 86c could be positioned slightly lower than edge 86d, to facilitate liquid drainage along surface 86a, toward gap 92; and, to facilitate gas flow maintaining a spiral flow in region 26, after passage through gap 92.

Because the inlet 12 is a radial inlet 12a, initial flow of a gas/liquid combination into the pressure vessel 5, directed toward central axis 47, is not automatically directed into a spiral flow pattern. To facilitate flow direction into a spiral pattern, the preseparation arrangement 82 includes a radial flange or vane 100 therein, FIG. 2. The flange or vane 100 extends upwardly from surface 86a in a direction opposite to the direction of declination of skirt 86 and will operate to close one direction of possible flow for inlet gases, during operation. For the particular arrangement shown in FIG. 2, the flange 100 is positioned to prevent a counter-clockwise flow, (i.e., counter-clockwise when looking down toward cover 7 of assembly 1 in FIGS. 1 and 2, in the direction of arrow 105). (Of course the equipment could be configured for an opposite direction of flow.) It is expected that the flange 100 will typically be located a radial spacing or distance of no more than 45°, typically no more than 30° from the closest edge of inlet 12. Indeed, vane 100 is preferably located as close to the inlet 12 as possible. In FIG. 2, the approximate location of inlet 12 is shown at 12b for a preferred embodiment as shown in FIGS. 1-3, preferably vane 100 is positioned spaced radially, in the direction gas flow, at least 200° from gap 93, typically at least 230°, more preferably at least 250°.

Still referring to FIG. 2, for the particular arrangement shown, the axial shroud 85 comprises a portion 110 of an outer surface 36a of wall 36. Further, the axial shroud 85 has a radially continuous outer surface 85a, in this instance cylindrical, and thus creates an annular flow region 111 (FIG. 1) between the shroud 85 and wall inner surface 87. There is no specific requirement that the shroud 85a be cylindrical. However, when a single cylindrical separator 10 is involved, and a cylindrical outer wall 71 is used, typically and preferably a cylindrical shape for the shroud 85 will be used.

Referring to FIG. 1, preferably relief valve tap 45 extends through wall 71 into communication with flow region 111. Typically and preferably, the relief valve tap 45 (instead of being located about 180° around wall 71 from inlet 12 as shown in FIG. 1), is located adjacent vane 100, FIG. 2, on an opposite side thereof from inlet 12. In FIG. 2, the relief valve tap 45 would be located adjacent or in overlap with region 112.

It is foreseen that in some instances it would be preferred to provide an overall cross-sectional area for region 111, i.e., a cross-sectional area for the volume defined by the outer wall 71, flange 35, shroud 85 and baffle 86, which has about the same area as the cross-sectional area or inlet area of inlet 12. In this manner, the flow velocity around annulus 111 will not increase substantially relative to the flow velocity through inlet 12. Avoidance of a large increase in flow velocity in this region will generally be preferred, since it will help avoid entrainment (into the gas flow) of separated liquid.

In addition, a large flow velocity reduction in region 111 will preferably be avoided to avoid loss of centrifugal force used for separation of some liquid droplets by driving them against wall 71, while the gases flow around shroud 85.

For a typical preferred arrangement, the upper surface 86a of radial skirt 86 will extend in radial extension from waist or interior edge or region 113 to outer edge or exterior region 114 at a declination angle A, FIG. 2, the order of at least about 20°, typically at an angle within the range of 20° to 80° inclusive (for example typically 30°-60°, and for the specific example shown 40°-50°). The term “decline” and variants thereof in this instance refers to a downward angle when the arrangement is oriented for normal use with drain 16 directed downward. In general, the choice of declination angle A will in part be a function of ensuring that the appropriate cross-sectional area is region 111 is provided. In addition, it will be chosen to facilitate a rate of flow of the bulk liquid or toward wall 71.

In general, it will be preferred to position skirt 86 as high as reasonably possible, within housing 1, taking into account the above preference for the size of annulus 111. The reason for the preferred mounting as high as possible, is that it is preferred to maximize the amount of surface area of wall 71, in the region between the underside 86e of skirt 86, and lower edge 36b of shroud 36, FIG. 1. Maximizing surface area of wall 71 in this location, will facilitate centrifugal separation of liquid as the air passes through gap 92, in a swirling pattern, and passes under lower edge 36b of shroud 36 to begin to enter aperture 33.

Preferably, edge 86b of skirt 86 is positioned at least 35% of the distance toward ring 35 from lower edge 36b of shroud 36 (i.e., 35% of the axial length of shroud 36 (or shroud 85), more preferably at least 40% of that distance, typically at least 50% of that distance.

In the preferred embodiment shown, the downcomer channel 92, FIG. 2, is a gap provided in skirt 86 which extends completely between shroud 85 and the wall 71 (FIG. 1). An advantage to this is that as both liquid and gases flow downwardly through the downcomer or channel 92, the gases do not expand underneath the skirt 86, toward the shroud 85 or the wall 71, with a risk of re-entrainment of liquid. Typically and preferably, a radial width of the downcomer channel 92 will be at least 90% of the distance of extension of the skirt 86, between inner waist or edge 113 and outer edge 114 (or 86b). Preferably it will be at least 95% of the distance, most preferably 100% of the distance, as shown.

The downcomer or channel 92, FIG. 2, is generally located to begin at edge 93a spaced (in the direction of gas flow) at a radial position relative to center line 47 (FIG. 1) of the inlet 12, at an angle of at least 70°, typically at least 180°, often at least 230°, for the example shown about 250° to 340° around the shroud 85. Also, preferably gap or downcomer channel 92 is radially spaced at least 200° from vane 100, more preferably at least 230°, typically at least 250°, in the direction of gas flow. This will help provide an increased amount of liquid separation, before gas flow can leave preseparation arrangement 80. The radial length of the skirt 86 and the downcomer channel 92 are generally a matter of choice based upon desired flow rates and restrictions for the downcomer channel, usually a radial extension of at least about 30°, and not more than 130°, and typically 30°-80°, inclusive for example about 40° to 60°, will be used. The term “inclusive” when used herein in reference to a range, is meant to indicate that the end points are included in the stated range. All stated ranges are intended to be “inclusive” even if the term is not specifically used.

The principles described can be applied, as indicated, in a variety of units of a variety of sizes and applications. The following dimensions are indicated, to facilitate an understanding of how the principles might be applied. For example if assembly 1 is for use with a compressor having an engine rating of about 125 hp (about 93 Kw) and an expected through put of about 500 cfm (about 236,000 cu.cm/sec), the unit could be configured with: a housing having an overall diameter of about 9-11 inches (22.8-28 cm) (for example 10 inches or 2.5 cm) and an overall height of about 40-45 inches (about 101 cm-115 cm), (for example 42 inches or 107 cm); and, a separator 10 having a length of about 20-25 inches (about 50-64 cm) (for example 22 inches or 56 cm), an outside diameter of about 5-6 inches (about 12-15.3 cm) (for example 5.5 inches or 14 cm) and an inside diameter of about 3-4 inches (about 7.6-10.2 cm) (for example 3.5 inches or 8.9 cm). The distance between base 37 and the liquid level 41a in the sump 40, would generally be chosen so that: it was sufficiently large to inhibit re-entrainment of liquid collected in the sump, by gases moving toward aperture 33; and, sufficiently short to minimize the overall height of the assembly 1, for convenience and cost savings. A distance on the order of 30%-60% of the liquid depth, will be typical.

Referring to FIG. 1, it should be noted that a substantial advantage is provided by having wall 36 extend longitudinally along separator 10 a distance of at least 20% of an axial length of the separator 10, or the mounting space in which the separator 10 is positioned, preferably at least 35% of this length. The reasons for this include that this creates an effective and preferred location for entrance 12 and annulus 111, for facilitating separation, while at the same time minimizing a distance between base 37 and level 41a of liquid in sump 40.

Preferably wall 36 does not extend longitudinally long separator 10 any greater than about 60% the length of separator 10, or the mounting space in which the separator 10 is positioned, more preferably no more than 50% of this length. A reason is the desire to maintain a flow rate in region 25 which does not tend to reentrain liquid draining into sump 39. The general flow rate on the order of about 400 ACFM (Actual Cubic Feet Per Minute, i.e. measured in terms of the compressed air and not free air, or about 18,900 cu.cm/sec) will typically accomplish substantial gas flow without undesirable levels of reentrain.

Referring to FIG. 3, a preferred radial skirt 115, useable as skirt 86, is depicted. The skirt 115 is preferably a single, integral, radially discontinuous ring construction with the vane 100. It would typically be formed from a single sheet of metal, for example with a press operation. For example, 18 gauge (0.05 inch thick or 0.13 cm thick) steel could be used. It could be secured in place, for example, by arc welding.

### III. An Embodiment Utilizing Multiple Serviceable Separator Elements

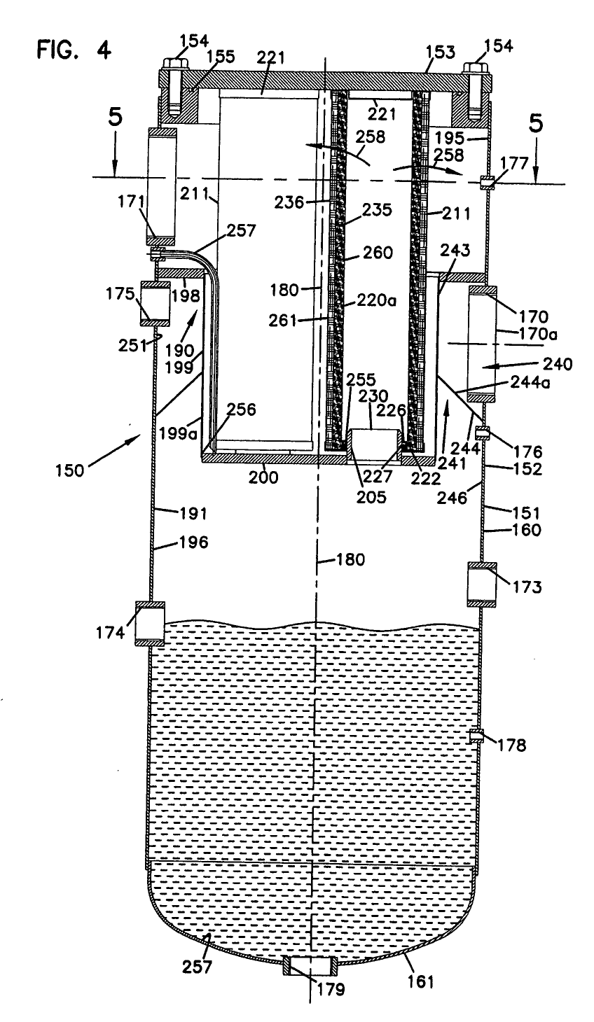

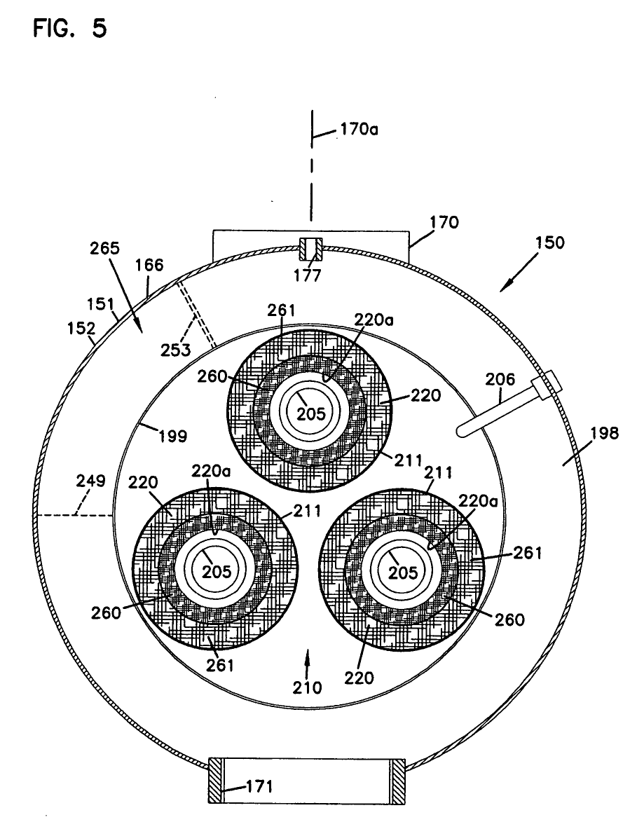

The principles described above can readily be applied in a gas/liquid separator assembly which utilizes more than one removable and replaceable separator element. An example of this is indicated in FIGS. 4 and 5. The arrangement of FIGS. 4 and 5, is configured to use separator elements identical to separator element 10 (i.e., of the same size and construction). However, the assembly of FIGS. 4 and 5 is configured for use with compressor having an engine rating of 450 hp (about 335 Kw), and an expected through put on the order of 2,000 cfm (about 945,000 cu.cm/sec). To manage this larger flow, then, it will be seen that three separator elements are used, in this instance in a housing having a diameter of about 16-20 inches (about 40-51 cm) (for example about 18 inches or 45.7 cm) and having a height of about 45-55 inches (about 114-140 cm) (for example about 50 inches or 127 cm). Of course, the principles can be applied in an assembly having more or fewer separators, depending upon the compressor rated size and expected through put.

Referring to FIG. 4, gas/liquid separator 150 is depicted, comprising vessel 151. The vessel 151 generally includes a housing 152 and a cover 153. The cover 153 is secured in place by bolts 154 with o-ring 155 providing a seal there between.

As with the embodiment of FIGS. 1-3, the housing 152 generally has an outer cylindrical wall 160 and a rounded bottom 161. A radially directed inlet 170 is depicted, projecting through wall 160. In addition, the gas/liquid separator assembly 150 is shown with an upper outlet 171, a filler pipe 173, a liquid level gauge 174, relief valve tap 175, pressure tapings 176, 177, temperature probe tap 178 and lower drain 179. As with the embodiment of FIGS. 1-3, the pressure tap 175 is depicted rotated, around outer wall 160, and axis 180 about 180° from inlet 170. This would not be a preferred location for relief valve 175. Rather a preferred location would be analogous to the location described as preferred for the embodiments of FIGS. 1-3. This location is indicated below.

In general, tube sheet construction 190 separates interior 191 of pressure vessel 151 into upper region 195 and lower region 196. The tube sheet construction 190 generally comprises annular mounting ring 198, downwardly directed wall 199 and base 200. The tube sheet construction 190 is generally solid and impervious to gas flow therethrough, except through selected apertures 205, for gas flow into a liquid separator elements, as characterized further below. As indicated previously, the arrangement 150 is configured for use with a plurality of removable and replaceable (serviceable) separator elements. For the particular arrangement 150 depicted, the base 200 includes three gas flow apertures 205 therein, FIG. 5. In FIG. 5, a probe 206 is also depicted.

For the particular embodiment shown, the downwardly directed wall 199 is radially continuous. The wall 199 is also depicted as a cylindrical wall 199a. This is because a cylindrical wall such as wall 199a, can conveniently surround three separator elements as characterized below and as shown in FIG. 5.

If a different number of separator elements is used, a different shape may be preferable for wall 199. For example if two elements are used, it may be preferable to configure wall 199 in a racetrack shape. A racetrack shape generally has two opposite parallel side walls, with curved ends completing the circuit. With such a radially continuous wall, a preferred flow pattern utilizing two elements could be created.

Assembly 150 includes a removable and replaceable separator arrangement 210 comprising three individual removable and replaceable separator elements 211. The three elements 211 are depicted surrounded by wall 199, in FIG. 5. In FIG. 5, three individual elements 211 are shown evenly, radially, spaced around center axis 180 (FIG. 4); and, wall 199 is depicted as cylindrical. The elements 211 may be the same as element 10, FIG. 1. As with the embodiment of FIGS. 1-3, wall 199 extends along at least 25%, preferably at least 35% (most preferably not more than 50%) of the axial length of the separators 211, FIG. 4.

In general, for separator arrangement 150, FIG. 5, each of the three serviceable separator elements 211 may have generally the same configuration, with each comprising media pack 220 configured cylindrically, with first and second opposite end caps 221, 222 (FIG. 4). In general, end caps 221, 222 may be generally analogous to end caps 50, 56, FIG. 1. That is one end cap 222 has an open central aperture 225, for gas flow into media pack interior 220a. The central apertures 225 are generally surrounded by a sealing ring 226, for example o-ring 227. The seal ring 226 is configured to form a radial seal with cylindrical piece 230, one associated with each aperture 205 in base 200. Alternate seal arrangements, for example, as described above are useable.

End caps 221, on the other hand, are generally closed, i.e., do not contain apertures extending there through in flow communication with region 220a.

The axial length of the separator element 211, FIG. 4, is a little shorter than the distance between base 200 and cover 153. Again, the radial seal is preferably configured to allow some sliding motion of the separator elements 211, axially, for convenience.

Separator assembly 150 is an in-to-out flow arrangement, with respect to the multiple removable and replaceable separator elements 211. Tube sheet construction 190, then, separates the arrangement 150 appropriately, for an upstream side 235 and downstream side 236, relative to the various media packs 220. Inlet 170 is directed for eventual gas flow into upstream side 235. The particular inlet 170 shown, is a radial inlet 170a.

The gas/liquid separation arrangement or assembly 150 includes a preseparator arrangement 240 generally including an inlet baffle arrangement 241.

The inlet baffle arrangement 241 includes axial shroud 243 and inlet skirt 244. For the particular preseparation arrangement 240 depicted, the axial shroud 243 is radially continuous and it is also cylindrical, and is defined by an outer surface 199a of cylindrical side wall 199. The inlet skirt 244 may be generally analogous skirt 86 above except sized appropriately, and generally extends radially between axial shroud 243 and inside surface 246 of wall 160. The radial skirt 244 has an upper surface 244a which is preferably configured to provide a drainage surface toward inside surface 246 of wall 160. The radial skirt 244 preferably extends at an downward or declination angle (analogous to angle A, FIG. 2) of at least 20°, typically 30° to 60°, (for example 40°-50°) in this region.

Again, the radial skirt 244 may be shaped and positioned analogously to skirt 86, FIG. 3, for example with an analogous downcomer or channel 249 positioned at least 70°, typically at least 180°, usually at least 230° (and for the embodiment shown preferably 250°-340°), radially (in the direction of gas flow) from inlet line 170a of inlet 170, FIG. 5.

For the arrangement depicted in FIG. 4, generally the inlet baffle 241 defines flow annulus 251 between axial shroud 243 and inside surface 246 of wall 160. The flow annulus 251 preferably has a cross-sectional area about the same as the cross-sectional size of inlet 170.

For the particular arrangement shown, the inlet baffle 241 includes a radial vane 253, FIG. 5, (analogous to vane 100, FIG. 2) positioned to direct inlet gas flow, in a clockwise direction when viewed from the orientation of FIG. 5. Of course an alternate flow direction could be used, with the downcomer channel 249 positioned appropriately. The vane 253 will typically be positioned as close to the inlet 170 as possible. For the embodiment shown, the vane 253 is preferably radially spaced in the direction of gas flow at 200°, typically at least 230°, more preferably at least 250°, from channel 249.

Referring to FIG. 4, in operation a gas/liquid flow would enter arrangement 150 through radial inlet 170. A portion of liquid collected on inlet baffle 241, would drain downwardly into lower sump 257, for drainage out of drain 179. Gas flow would eventually pass under a lower edge of wall or shroud 243 through tube sheet construction 190 into the individual separators 211. With an in-to-out flow, the gas flow would pass through the media packs 220 in the direction of arrows 258. Within the media pack 220, coalescing drainage would occur, with liquid flow draining into upper sump 256. Liquid collected in the upper sump 256 would be removed, by scavenge tube 257. Gas flow would exit separator arrangement 150, through outlet 171.

As with the embodiment of FIGS. 1 and 2, the particular construction of the media packs 220 is not critical, to the general principles disclosed herein. In general, what is required is an inside coalescing stage 260 and an outside drain stage 261, configured for a desired level of efficiency with an in-to-out flow, along with: desirable efficiency; restriction; air flow rate; and, service life. Various scrim layers or liners can be utilized, if desired.

Periodically, when separator elements 211 are scheduled to be replaced, a replacement operation can be conducted by removing cover 153 upon loosening of bolts 154.

Referring to FIG. 5, the preferred radial location of the vane 253 relative to inlet 170, is shown. Also a preferred radial location and extension for the downcomer 249, is shown. At 265 preferred radial location of the relief valve aperture 175 relative to the inlet 170 is depicted. This position differs from the position indicated in FIG. 4, which is a less preferred position. As with the embodiment of FIGS. 1-3, the preferred position locates the relief valve over the downcomer, and thus ensures a relatively high level of gas/liquid separation before gases would be likely to reach the relief valve aperture, during a relief valve operation.

Other structural preferences stated for the embodiment of FIGS. 1-3 would analogously apply to the embodiment of FIGS. 4-5.

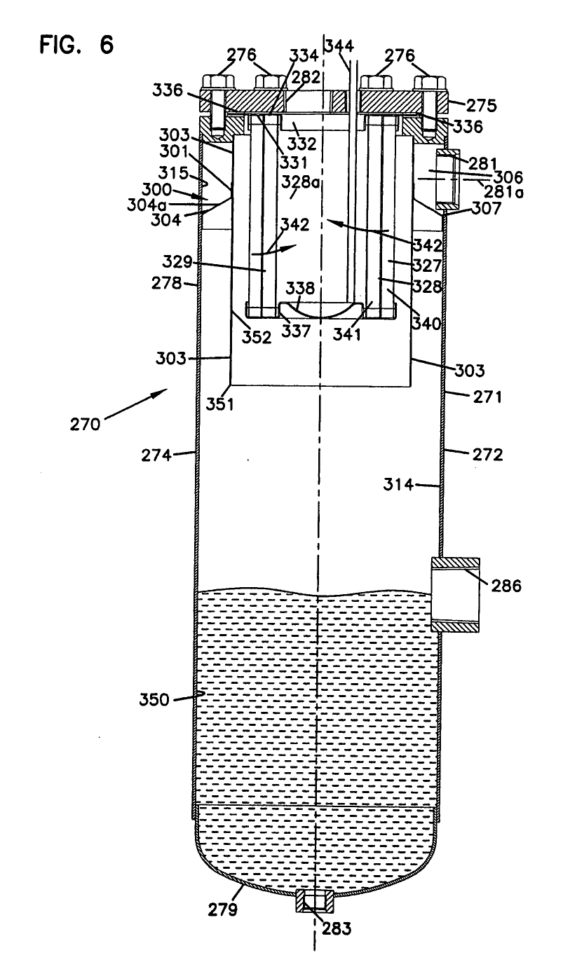

### IV. The Embodiment of FIGS. 6-8, an Assembly Utilizing and Out-to-In Flow Separator Element

As previously indicated, the principles described herein in connection with the inlet baffle arrangement, can be applied in a gas/liquid separator arrangement configured for use with removable and replaceable separator elements that are configured for out-to-in flow. An example of such an arrangement, depicted for use with a single removable and replaceable separator element, is shown in FIGS. 6-8. From this, and the general principles described, an arrangement involving more than one separator element will be apparent.

The particular assembly depicted in FIGS. 6-8, is configured for use with a relatively small compressor, for example a compressor having an engine rating of about 20 to 100 hp (or about 14.9-74.6 Kw) (for example 40 hp or about 30 Kw), with an anticipated through put of about 185 cfm (or about 87,300 cu.cm/sec). Such an assembly would have an outside diameter of about 7-9 inches or 17-23 cm (for example 8 inches or 20.3 cm), and total height of about 27-33 inches or 68-84 cm (for example 30 inches or 76 cm). However, the principles described can be applied in a variety of arrangements, for a variety of sizes of compressors.

Referring to FIG. 6, in general gas/liquid separator assembly 270 comprises vessel 271, in this instance pressure vessel 272 having a housing 274 closed by removable cover 275. The cover 275 is secured in place by bolts 276.

For the particular assembly 270 depicted, the vessel 271 has a generally cylindrical outer wall 278 and rounded bottom 279. The vessel 272 includes gas flow inlet 281, gas flow outlet 282 and liquid drain 283.

Also included within the assembly 270 is a liquid level port 286.

The assembly 270 can include a variety of liquid fill ports, pressure taps, temperature probes and pressure relief outlets generally analogous to those described from the previous embodiments, but appropriately positioned for application here, if desired.

The gas/liquid separator assembly 270 generally includes a preseparator 300 including an inlet baffle arrangement 301. The inlet baffle arrangement 301 includes axial shroud 303 and radial inlet skirt 304. In general, gas flow annulus 306 is defined between axial shroud 303 and inner surface 307 of wall 278. The annulus 306 is preferably sized to have about the same cross-sectional area as the inlet 281.

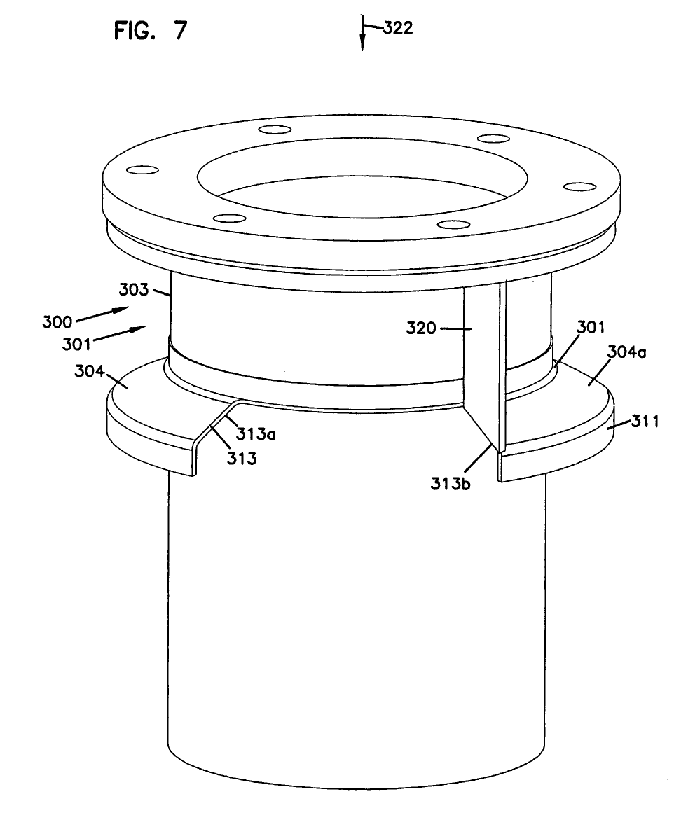

For the embodiment shown shroud 303 is radially continuous. The preferred shroud depicted is cylindrical, although alternatives are possible. Upper surface 304a of the preferred radial inlet skirt 304 preferably defines a drainage surface, draining radially downwardly from inner edge, waist or region 310 (FIG. 7) adjacent axial shroud 303 to outer edge or region 311 adjacent inner surface 307 of wall 278. The downward declination angle is preferably at least 20°, typically 30°-60° (for example 40°-50°).

The radial skirt 304 includes a downcomer or channel 313 therein, FIG. 7, to allow liquid drainage and gas flow into lower region 314 from upper region 315, during use. The channel 313 preferably has a radial width of at least 90%, preferably at least 95% of the radial extension between edges 310, 311.

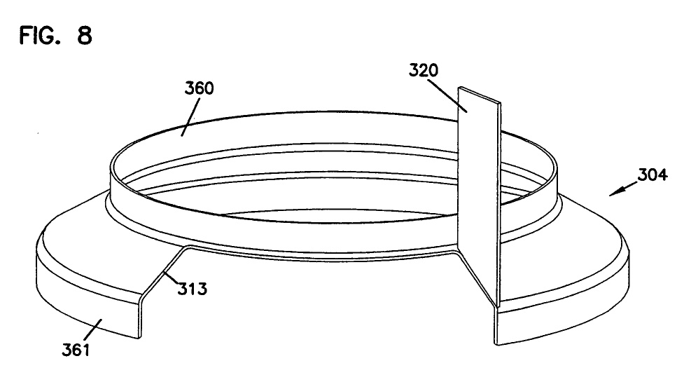

The inlet baffle arrangement is depicted in FIG. 7. The radial skirt is depicted in FIG. 8.

The inlet baffle 301 includes radial vane 320 therein, positioned as a direction vane to cause gas flow to travel in a defined direction; in the instance of the arrangement depicted in FIGS. 6-8, counter clockwise when looking downwardly on the arrangement from the direction of arrow 322, FIG. 7. The downcomer channel 313 is preferably positioned spaced radially at least 70°; more preferably at least 180°, typically at least 230°, (for example 250°-340°) from a center line 281a of radial inlet 281, FIG. 6. Preferably the channel 313 has a radial length between edges 313a, 313b (FIG. 7) of at least 30° typically 40°-130°, for example about 60°-80°.

Referring to FIG. 6, gas/liquid separator assembly 270 includes removable and replaceable (i.e., serviceable) separator element 327 therein. The element 327 comprises a media pack 328, in this instance a cylindrical media pack 329, in extension downwardly from end cap 331. End cap 331 has a central gas/flow aperture 332 therein. Gas flow aperture 332 is an outlet aperture for gases to escape inner region 328a defined by media pack 328.

For the particular arrangement depicted, the separator element 327, for example, could have an OD of about 4-6 inches or 10-15.3 cm (for example 5 inches or 13 cm), an ID of about 2-3 inches or 5-7.6 cm (for example 2.75 inches or 7 cm), an overall length of about 6-7 inches or 15.2-12.8 cm (for example 6.75 inches or 17.1 cm). Of course, the arrangement could be configured to use elements of alternate sizes, if desired.

Referring to FIG. 6, end cap 331 includes an annular mounting flange 334 thereon, positioned secured between cover 275 and housing 274, by bolts 276. Gasket material 336 is positioned, to provide a seal.

Element 327 further includes closed end cap 337. End cap 337 includes an internal liquid collection sump or bowl 338 therein.

The particular configuration in the media pack 328, as with other arrangements described herein, is not critical. In general the media pack 328 will comprise an outer coalescing portion 340 and an inner drain stage 341. Since flow is from out-to-in, i.e., in the direction of arrows 342 in normal use, liquid will collect in region 338 of end cap 331. Scavenge tube 344 is positioned, to remove liquid from this location in normal use.

In typical use, gas/liquid mixture to be separated, enters assembly 270 through inlet 281. The gas/liquid is first directed into preseparator assembly 300, with a portion of the liquid collecting against axial shroud 303 and radial skirt 304, FIG. 7. Liquid collected in this region will eventually flow through downcomer channel 313, to lower sump 350, FIG. 6, with drainage from lower sump 350 provided by drain 283. The gases would then pass underneath lower edge 351 of shroud 303, into region 352 around media pack 328. The gases will then pass through media pack 328, with further coalescing of liquid, and eventually drainage of liquid into internal sump 338 defined within interior 328a of media pack 328. The gases, reduced in liquid content, would then leave element 327 by passage through open end cap 331, and then leave vessel 271 through outlet 282.

Referring to FIG. 8, radial inlet skirt 304 preferably has an integral construction, with a vane 320 secured thereto. The vane 320 can be integral with a remainder of the skirt, or can be a separate piece attached. For the embodiment shown in FIG. 8, the vane 320 is a separate piece attached, for example by welding to project upwardly from inlet skirt or in a direction opposite the declination.

The remainder of the inlet skirt 304, not comprising the vane 320, is an integral construction typically metal formed in a spinning operation, with downcomer 313, cut out. Unlike the skirts 86, 244 for the embodiments of FIGS. 1-5, skirt 304 includes an inner axially (upwardly) directed waist portion 366, and an outer axially (downwardly) directed rim portion 361. These portions facilitate mounting within the assembly 270, by a spot weld operation.

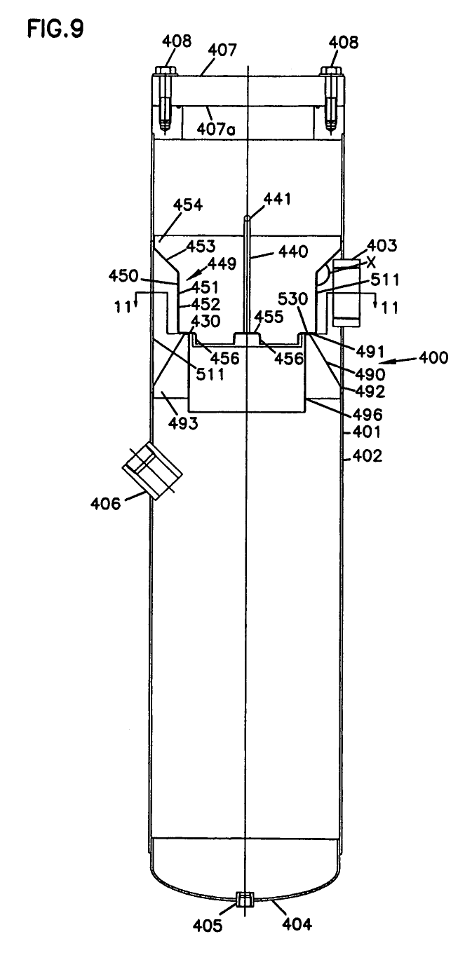

V. An Alternate Embodiment; FIGS. 9-12.

Attention is now directed to FIG. 9. FIG. 9 is a cross-sectional view of an assembly analogous to FIG. 1. Referring to FIG. 9, the assembly 400 depicted comprises a housing 401 having a cylindrical side wall 402 with an air flow inlet 403, a bottom sump 404 and drain 405. A liquid inlet for the bottom sump 404 is indicated at 406. The assembly includes a top cover 407 secured in place by bolts 408.

Except as described, assembly 400 may be generally analogous to, and have similar features to, assembly 1, FIG. 1.

Assembly 400 is depicted without separator elements positioned therein. It will be understood that in use separator elements would be positioned, for in-to-out flow, and would be located in the mounting space having an axial extension between top cover inner surface 407a, and surface 430.

In FIG. 2, gas exit 435 is depicted.

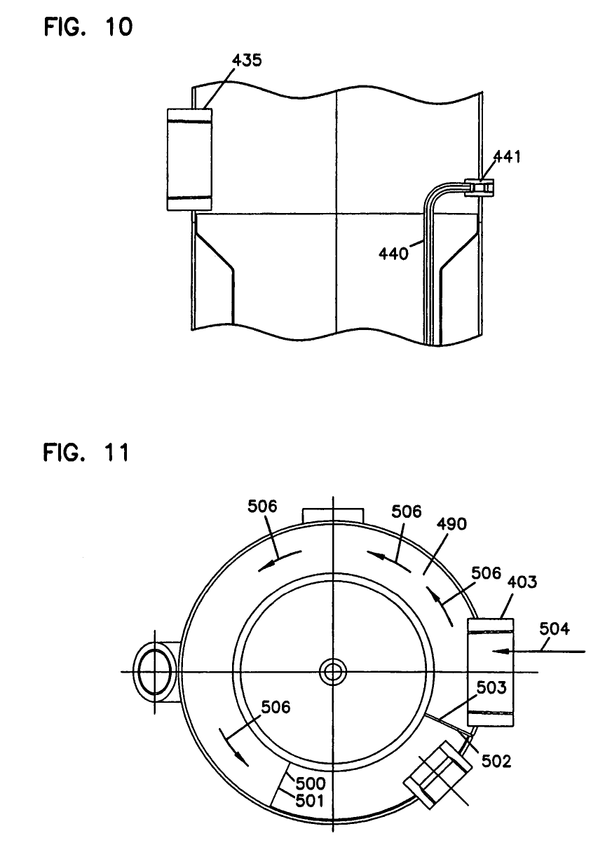

In FIGS. 9 and 10 draw tube 440 is depicted, extending through side wall 401 at tap 441.

Referring again to FIG. 9, assembly 400 includes a preseparator arrangement 449. The preseparator arrangement 449 includes tube sheet structure 450. The tube sheet structure 450 includes a wall section 451 having a lower section 452 and an upper section 453. The lower section 452 is generally cylindrical, and the upper section 453 generally has a funnel shape, i.e., a shape with a sidewall extending at an angle relative to the lower section, defining an angle X on the order of 120°-170°. The tube sheet structure 450 is mounted at mounting flange 454, when oriented for use. The tube sheet structure 450 further includes bottom sheet 455, with flow apertures 456 therein.

As with the arrangement of FIG. 1, sidewall structure 451 is positioned to extend upwardly, along a preseparator arrangement positioned in extension between bottom 455 (i.e., surface 430) and top 407a a distance of at least 20% of the axial length of the mounting space, i.e., separator elements, typically at least 35%; and, preferably not more than 60% and more preferably not more than 50% of the axial length of the mounting space, i.e., of any separator element arrangement positioned inside of the volume circumscribed by wall 450. This height of extension is made by lower section 452, and the remainder by upper section 453. The flange 454 does not count in measuring this distance, since it is basically flush with the sidewall.

Still referring to FIG. 9, arrangement 400 further includes radial skirt 490 therein. The radial skirt 490 extends in declination, between tube sheet structure 450 at location 491 to outer side wall 401 at location 492. The radial skirt 490 includes lower mounting flange 493.

For the particular arrangement shown, a cylindrical baffle 496 is shown positioned in extension downwardly from bottom 455, inside a radial skirt 490 and around apertures 456.

The radial skirt 490, FIG. 11, includes a downcomer channel 500 therein defined between edges 501 and 502. An upper flange would be located adjacent edge 502. Thus air entering inlet 403 in the direction of arrow 504, FIG. 11, would be directed into a counter-clockwise flow as indicated by arrows 506. At edge 501, the air would be directed downwardly below inlet skirt 490. Downcomer 500 also provides a location for drainage downwardly of liquid collected in region 511, FIG. 9, between radial skirt 490 and tube sheet structure 450.

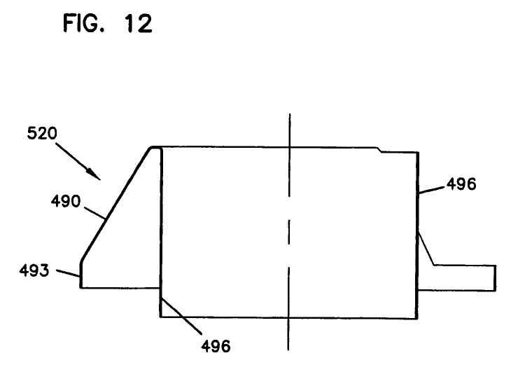

In FIG. 12, a radial inlet skirt arrangement 520 is depicted. It is shown having cylindrical shroud 496 formed integrally with skirt 490, along with flange 493.

The principles of operation of the arrangement represented by FIGS. 9-12, are analogous to those previous embodiments. FIGS. 9-12 show that a different mechanical connection of components can be used. Also, FIGS. 9-12 show a desirable funnel surface 453 in an upper portion of sidewall 451. Further, they show use of a second shroud 496, depending downwardly between apertures 456 and skirt 490, to ensure that air passing underneath skirt 490 needs to still go further downwardly until it can turn and be directed through tube sheet structure. This helps provide separation without undesirable levels of re-entrainment.

As with the previous embodiments, FIG. 9, in region 530 a sump is formed, from which liquid is removed periodically, or continuously, by draw tube 440, in use.

The arrangements of FIGS. 9-12 can be utilized with a variety of separator arrangements. It can be utilized with one or more separators, depending on how configured. The number of apertures in bottom 455, would correspond with the number of separators, in typical use. The separators may be cylindrical, or may have alternate shapes.

### VI. Some General Observations.

According to the present disclosure, preseparation arrangements for use in gas/ liquid separators, for example air/oil separators with compressors, are described. The preseparation arrangements generally include an axial shroud as characterized and an inlet skirt as characterized. Particularly preferred configurations of each, are shown and described.

Also according to the present disclosure, methods of generating an air/oil separator arrangement, or installing a preseparation arrangement, are provided. The methods generally include installing a preseparation arrangement as characterized, in a cylindrical vessel, attached to a vessel side wall appropriately. The preferred positioning would of course be with the gas flow inlet directed above the inlet skirt; and with radial positioning of the vane and skirt as characterized for the various embodiments.

A method of separating gas and liquid, for example air/oil from a compressor is also provided. The method generally involves directing inlet flow into a preseparation arrangement as described, passing gas flow underneath a lower edge of an axial shroud, and then passing the remaining gases through the serviceable separator element. Of course multi-element systems can be used.

The techniques described herein can apply to a variety of equipment types, with a variety of sizes and specific configurations. The general characterizations herein are meant to be preferred examples.

1-20. (canceled)

21. A gas/liquid separator assembly comprising:
(a) a vessel including an outer wall and having a gas flow inlet, a gas flow outlet and a lower sump;
(i) the vessel including a sidewall;
(ii) the gas flow inlet extending through the sidewall;
(b) a preseparation assembly comprising a tube sheet structure including:
(i) a radially continuous axial shroud comprising a depending central wall positioned spaced from the vessel outer wall to define a gas flow annulus therebetween;
(ii) an annular mounting ring extending between the axial shroud and the vessel sidewall and supporting the axial shroud; and,
(iii) a base having at least one aperture comprising a flow channel therethrough;
(iv) the tube sheet structure being positioned to separate an enclosed upper region from an enclosed lower region;
(v) the depending central wall and base generally defining an upper sump;
(vi) the gas flow inlet being positioned for gas flow into the enclosed lower region and into the gas flow annulus; and,
(vii) the gas flow outlet being positioned for gas flow out of the enclosed upper region; and,
(c) a mounting space for at least one removable and replaceable in-to-out flow separator element in the enclosed upper region surrounded by and spaced from the gas flow inlet by the axial shroud;
(i) the axial shroud extending along a distance of at least 20%, and not more than 60%, of an axial length of the mounting space for at least one removable and replaceable in-to-out flow separator element.

22. A gas/liquid separator assembly according to claim 1 including:
(a) a removable and replaceable in-to-out flow separator element positioned within the enclosed upper region in association with each flow channel in the base of the tube sheet structure.

23. A gas/liquid separator assembly according to claim 2 comprising:
(a) one removable and replaceable in-to-out flow separator element.

24. A gas/liquid separator assembly according to claim 2 comprising:
(a) two removable and replaceable in-to-out flow separator elements.

25. A gas/liquid separator assembly according to claim 2 comprising:
(a) three removable and replaceable in-to-out flow separator elements.

26. A gas/liquid separator assembly according to claim 1 wherein:
(a) the axial shroud extends along a distance of at least 35%, and not more than 60%, of the axial length of the mounting space for at least one removable and replaceable separator element.

27. A gas/liquid separator assembly according to claim 6 wherein:
(a) the axial shroud extends along a distance of at least 35%, and not more than 50%, of the axial length of the mounting space for at least one removable and replaceable separator element.

28. A gas/liquid separator assembly according to claim 1 wherein:
(a) the axial shroud is cylindrical.

29. A gas/liquid separator assembly according to claim 1 wherein:
(a) the gas flow inlet is a radial inlet.

30. A gas/liquid separator assembly according to claim 1 wherein:
(a) the gas flow outlet extends through the outer wall.

31. A gas/liquid separator assembly according to claim 1 including:
(a) an inlet skirt positioned below the gas flow inlet and extending to the vessel outer wall;
(i) the gas flow inlet being positioned to direct inlet gas flow into the gas flow annulus above the inlet skirt;
(ii) the inlet skirt including at least one downcomer channel at a location radially spaced from the inlet; and,
(b) a radial vane positioned between the downcomer channel and the gas flow inlet to direct gases through a radial path of at least 70° before the gases can pass from the gas flow inlet through the downcomer channel; and,
(c) at least one removable and replaceable separator element positioned, in the mounting space for at least one removable and replaceable separator element, surrounded by and spaced from the gas flow inlet by the axial shroud.

32. A gas/liquid separator assembly according to claim 11 wherein:
(a) the radial vane is positioned to direct gases through a radial path of at least 180° before the gases can pass from the gas flow inlet through the downcomer channel.

33. A gas/liquid separator assembly according to claim 12 wherein:
(a) the downcomer channel is spaced from the gas flow inlet, by a radial path of at least 230°.

34. A gas/liquid separator assembly according to claim 13 wherein:
(a) the downcomer channel has a radial extension of at least 30°.

35. A gas/liquid separator assembly according to claim 14 wherein:
(a) the downcomer channel has a radial extension of no more than 130°.

36. A gas/liquid separator assembly according to claim 15 wherein:
(a) the inlet skirt has an upper surface which slants downwardly in extension toward said outer wall.

37. A method of separating an air/oil mixture from compressor; said method including steps of:
(a) providing a gas/liquid separator comprising:
(i) a vessel including an outer wall and having a gas flow inlet, a gas flow outlet and a lower sump;
(A) the vessel including a sidewall;
(B) the gas flow inlet extending through the sidewall;
(ii) a preseparation assembly comprising a tube sheet structure including:
(A) a radially continuous axial shroud comprising a depending central wall positioned spaced from the vessel outer wall to define a gas flow annulus therebetween;
(B) an annular mounting ring extending between the axial shroud and the vessel sidewall and supporting the axial shroud; and,
(C) a base having at least one aperture comprising a flow channel therethrough;
(D) the tube sheet structure being positioned to separate an enclosed upper region from an enclosed lower region;
(E) the depending central wall and base generally defining an upper sump;
(F) the gas flow inlet being positioned for gas flow into the enclosed lower region and into the gas flow annulus; and, '(G) the gas flow outlet being positioned for gas flow out of the enclosed upper region;
(iii) a mounting space for at least one removable and replaceable in-to-out flow separator element in the enclosed upper region surrounded by and spaced from the gas flow inlet by the axial shroud;
(A) the axial shroud extending along a distance of at least 20%, and not more than 60%, of an axial length of the mounting space for at least one removable and replaceable in-to-out flow separator element; and,
(iv) a removable and replaceable in-to-out flow separator element positioned within the enclosed upper region in association with each flow channel in the base of the tube sheet structure; and,
(b) directing a fluid stream from the inlet:
(i) beneath a lower edge of an axial shroud;
(ii) through at least one removable and replaceable in-to-out flow separator element; and
(iii) outwardly through the outlet.
